(19) United States
(12) Patent Application Publication
(10) Pub. No.: US 2024/0415043 A1
(43) Pub. Date: Dec. 19, 2024

(54) TRACTOR WORK EQUIPMENT LINKAGE

(71) Applicant: FARMI FOREST OY, Iisalmi (FI)

(72) Inventor: Petri PELKONEN, Iisalmi (FI)

(21) Appl. No.: 18/712,618

(22) PCT Filed: Nov. 22, 2022
(86) PCT No.: PCT/FI2022/050776

§ 371 Date: May 22, 2024

(30) Foreign Application Priority Data
Nov. 23, 2021 (EP) 21209908.9

(51) Int. Cl. A01B 59/06; A01B 63/02; B62D 49/02

(52) U.S. Cl. CPC A01B 59/06; A01B 63/02; B62D 49/02

(57) ABSTRACT

A tractor linkage arrangement (10) to attach work equipment (20) to a tractor comprising a subframe (100), which is to be attached to a tractor chassis (11), comprising a first (103), a second (104), a third (105) and a fourth fixing point (106), a first support (101) comprising a first and a second spindle opening (107, 108), and a second support (102) comprising a third and a fourth spindle opening (109, 110), further comprising a first lifting arm (140), which is pivotally attached from its first end to the first support (101), a second lifting arm (141), which is pivotally attached from its first end to the second support (102), wherein the first lifting arm (140) is comprising a first lifting pin (142) on one side of the first lifting arm (140) and first gripping pin (144) on the other side of the first lifting arm (140), and wherein the second lifting arm (141) is comprising a second lifting pin (143) on one side of the second lifting arm (141) and a second gripping pin (145) on the other side of the second lifting arm (141), and a work equipment adapter (120), which is to be attached to a work equipment (20), the work equipment adapter comprising a first link arm (121) and a second link arm (122), a first, a second, a third and a fourth spindle opening (123, 124, 125, 126), wherein the first link arm (121) comprises a first grab (129) and the second link arm (122) comprises a second grab (130), wherein the first gripping pin (144) is to be fitted to the first grab (129) and the second gripping pin (145) is to be fitted to second grab (130).

### FIELD OF THE INVENTION

The invention relates to attaching work equipment to tractors, particularly to agricultural tractors.

### BACKGROUND OF THE INVENTION

Agricultural tractors have been used as general-purpose machines and platforms; wherein various work equipment have been connected based on the need at hand. These work equipment are for example typical agricultural tools like ploughs, spreader beams, harrows or other equipment like blades or cranes. A general and standardized attachment scheme for the above-mentioned machines has been created, which is the three-point attachment scheme also known as three-point linkage or three-point hitch system. The three-point linkage system includes two lower links and a top link to attach the work equipment to the tractor, and two lifting arms to raise and lower the work equipment for transport and for operation. Their dimensions have increased with the size of the base machines. Currently, there are three known work equipment attachments in use; CAT 1, CAT 2 and CAT3. These three-point linkage systems have their advantages, however also limitations.

One of the problems associated with the above arrangement is the system has limited possibility to attach heavy work equipment and on the other hand such heavy work equipment that cause high torque to the tractor frame structure (along its longitudinal axis).

### BRIEF DESCRIPTION OF THE INVENTION

An objective of the present invention is thus to provide a new arrangement for implementing the attachment. The arrangement is characterized by what is stated in the independent claims. Some embodiments of the invention are disclosed in the dependent claims.

The new linkage system based on the invention does not exclude the above-mentioned CAT 1-CAT 3 attachments or their utilization in the tractor but allows one additional stable implement arrangement and controlled transfer of implement forces to the tractor chassis. Therefore, the tractor's mass and properties can be used to the maximum for stability and tall torque, when using work equipment. The arrangement of the implement also enables safe coupling and uncoupling of the work equipment from the tractor, which must be repeated within a reasonable time.

The invention is based on the idea of providing an additional work equipment linkage arrangement which supports heavy work equipment while maintaining the possibility to attach the standard CAT 1-CAT 3 equipment using the three-point linkage system. The key components of the arrangement are a subframe, which is to be attached to the tractor frame structure, a work equipment adapter, which is to be attached to a work equipment and a linkage mechanism, which grabs the work equipment and lifts it against the subframe supports so that the work equipment is firmly mounted to the subframe. The subframe and the linkage mechanism are positioned to the tractor frame structure so that lifting arms of the linkage mechanism receive the movement energy from the tractor's three-point linkage system lifting arms. The mounting is fastened by inserting spindles to the aligned spindle openings in the adapter and in the subframe supports.

### BRIEF DESCRIPTION OF THE DRAWINGS

In the following the invention will be described in greater detail by means of some embodiments with reference to the accompanying drawings, in which

FIG. 1 illustrates schematically a tractor and the tractor work equipment linkage arrangement;

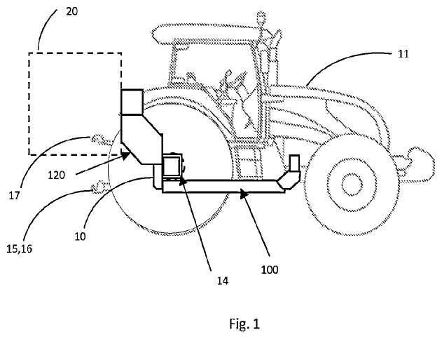

FIG. 2 illustrates schematically work equipment arrangement components in a detached position;

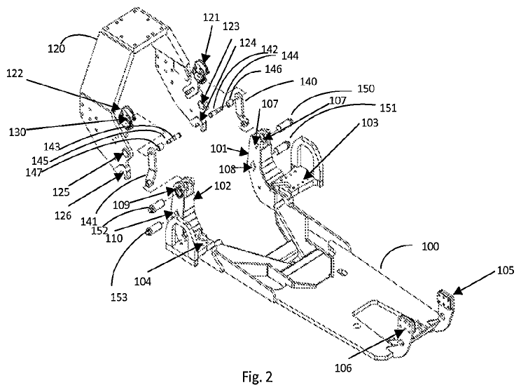

FIG. 3 illustrates schematically from the side view a cross-section of the work equipment and the tractor lifting arm, when the tractor lifting arms are at the low position;

FIG. 4 illustrates schematically from the side view a cross-section of the work equipment arrangement, when the tractor lifting arms are raised and the work equipment adapter is positioned against the subframe supports;

FIG. 5 illustrates schematically from the front view with respect to the tractor an embodiment of the work equipment arrangement, where lifting pins 142, 143 are displaced from gripping pins 144,145; further in a position, where the tractor lifting arms are raised and the work equipment adapter is positioned against the subframe supports 101, 102;

FIG. 6 illustrates schematically from the top view the work equipment arrangement, when the tractor lifting arms are raised and the work equipment adapter is positioned against the subframe supports.

### DETAILED DESCRIPTION OF THE INVENTION

It will be obvious to a person skilled in the art that, as the technology advances, the inventive concept can be implemented in various ways. The invention and its embodiments are not limited to the examples described above but may vary within the scope of the claims.

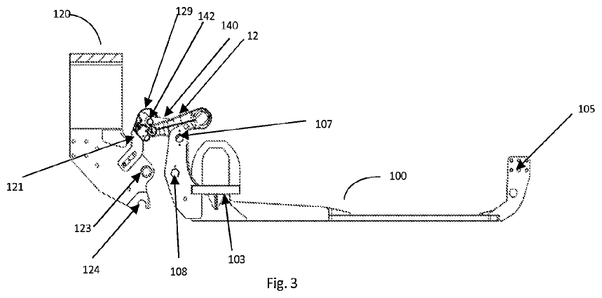

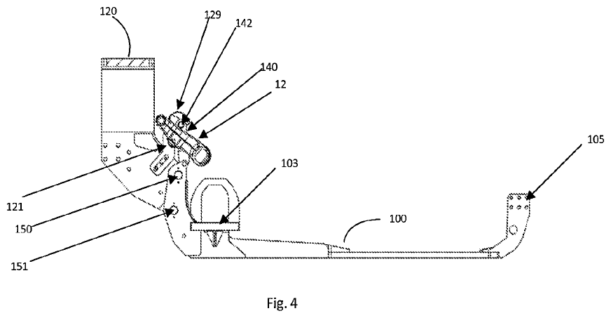

According to an embodiment of the invention, the tractor work equipment linkage arrangement 10 is attached to the tractor frame structure so that tractor lifting arms 12, 13 can lift the lifting arms 140, 141 via the lifting pins 142, 143, and thus also lift the work equipment 20 via the gripping pins 144, 145. The dimension and position of the lifting arms 140, 141 are adjusted so that the vertical position of the gripping pins 144, 145 can be adjusted to fit the grabs 129, 130 in the work equipment adapter 120 attached to the work equipment 20, when placed on the ground. This is illustrated in FIG. 3. The dimensions are further adjusted so that the movement of the tractor lifting arms 12, 13 moves the work equipment 20 with the work equipment adapter 120 against the subframe 100 supports 101, 102 such that the spindle openings 123, 124, 125, 126 of the work equipment adapter 120 and spindle openings 107, 108, 109, 110 of the subframe 100 are aligned. The fastening of the work equipment adapter 120 can be done by inserting spindles 150, 151, 152, 153 to the aligned spindle openings 123, 124, 125, 126 of the work equipment adapter 120 and spindle openings 107, 108, 109, 110 of the subframe 100. This is illustrated in FIG. 4. The spindles 150, 151, 152, 153 can be secured for example with cotter pins in the spindles or by providing screw threads in the spindles 150, 151, 152, 153 and by providing nuts to the spindles 150, 151, 152, 153. The dimensions of the spindles 150, 151, 152, 153 can be machined with a tight fit to provide very stable operation for example when using the work equipment 20 for a reasonably long period of time. Alternatively, the dimensions of the spindles 150, 151, 152, 153 can be provided with a less tight fit to provide easier operation of mounting and dismounting of the work equipment, when mounting and dismounting need to be repeated more frequently.

According to another embodiment of the invention, the subframe 100 first fixing point 103 and second fixing point 104 can be attached to the rear axle 14) of the tractor 11. In this embodiment, the arrangement 10 can implement controlled transfer of the forces to the frame structure of the tractor caused by torque originating by the work equipment.

According to another embodiment of the invention the lifting pins 142,143 in the lifting arms 140, 141 are provided with bearings 146, 147 on the other side of the lifting arms 140, 141 so that the bearings 146, 147 are to be fitted on top of the tractor lifting arms 12, 13 to provide a fluent motion of the pins 142, 143, when the tractor lifting arms 12, 13 are lifted or lowered.

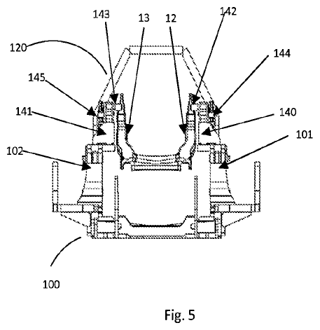

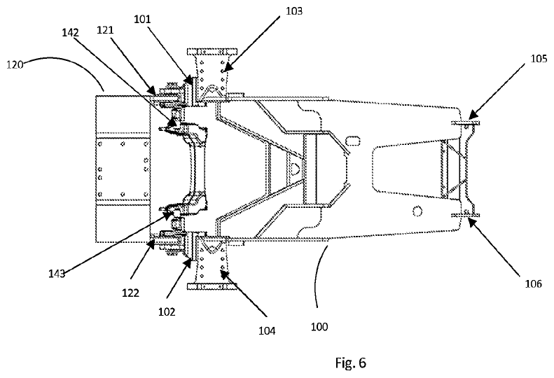

According to another embodiment of the invention the lifting arms 140, 141 comprise lifting pins 142, 143 on one side of the lifting arms 140, 141 and gripping pins 144, 145 on the other side of the lifting arms 140, 141 displaced from the lifting pins 142, 143. In this embodiment, the placement of the lifting pins 142, 143 in relation to the gripping pins 144, 145 is adjusted to provide optimal lifting energy to the lifting arms 140, 141. This is illustrated in a front view of the arrangement 10 in FIG. 5, wherein the lifting pins 142, 143 are displaced from the gripping pins 144, 145. FIG. 6 illustrates the same from the top view.

According to another embodiment of the invention the lifting arms 140, 141 comprise lifting pins 142, 143 on one side of the lifting arms 140, 141 and gripping pins 144, 145 on the other side of the lifting arms 140, 141 which are aligned with the lifting pins 142, 143. In this embodiment the lifting pins 142, 143 and the gripping pins 144, 145 can be attached as single components, respectively, extending on both side of the lifting arms 140, 141.

According to another embodiment of the invention, the lower spindles, that is, the second and the fourth spindle 151,153 are fixed to the subframe 100. In this embodiment, the second and the fourth spindle opening 124, 126 of the work equipment adapter 120 are slots so the work equipment adapter 120 can be fitted on top of the fixed second and fourth spindle 151,153, respectively. The first and the third spindle 150, 152 are to be inserted in the spindle openings 107, 109 of the subframe 100 and the spindle openings 123, 125 of the work equipment adapter 120.

The subframe 100 is attached to the tractor 11 so that the subframe 100 does not exclude the use of CAT 1-CAT 3 attachments, thus maintaining the possibility to attach the standard CAT 1-CAT 3 equipment using the three-point attachment scheme. While the subframe 100 is permanently attached to the tractor 11, the work equipment adapter 120 can be attached to the tractor via the subframe 100. When a CAT 1-CAT 3 equipment—an agricultural tool like a plough, a spreader or a harrow-needs to be attached to the tractor, the work equipment adapter 120 is detached from the subframe 100, and then the CAT 1-CAT 3 equipment is attached to the first lower link 15, the second lower link 16 and the top link 17 of the three-point linkage without the subframe 100 disturbing the attachment of the CAT 1-CAT 3 equipment. The disclosed subframe 100 and the spindle openings 107, 108, 109, 110 of the subframe 100 are positioned essentially closer to the rear axle 14 of the tractor 11 than the outermost ends of any of the first lower link 15, the second lower link 16 and the top link 17 of the three-point linkage. Thus the work equipment linkage arrangement 10 does not prevent the use of CAT 1-CAT 3 attachments via the three-point linkage system while the subframe 100 is attached to the tractor.

1.-11. (canceled)

12. A tractor work equipment linkage arrangement comprising:
a subframe, which is to be attached to chassis of a tractor, comprising a first fixing point, a second fixing point, a third fixing point and a fourth fixing point, a first support comprising a first and a second spindle opening, and a second support comprising a third and a fourth spindle opening;
a first lifting arm, which is pivotally attached from its first end to the first support, a second lifting arm, which is pivotally attached from its first end to the second support,
wherein the first lifting arm comprises a first lifting pin on one side of the first lifting arm and first gripping pin on the other side of the first lifting arm, and
wherein the second lifting arm comprises a second lifting pin on one side of the second lifting arm and a second gripping pin on the other side of the second lifting arm, and
a work equipment adapter, which is to be attached to a work equipment, the work equipment adapter comprising a first link arm and a second link arm, a first, a second, a third and a fourth spindle opening, wherein the first link arm comprises a first grab and the second link arm comprises a second grab,
wherein the first gripping pin is to be fitted to the first grab and the second gripping pin is to be fitted to second grab.

13. A tractor linkage arrangement according to claim 12, wherein the subframe first fixing point and second fixing point are to be attached to the rear axle of the tractor.

14. A tractor linkage arrangement according to claim 12, wherein the first lifting pin is provided with a first bearing and the second lifting pin is provided with a second bearing.

15. A tractor linkage arrangement according to claim 12, wherein the lifting pins are to be fitted on top of the tractor lifting arms, wherein the tractor lifting arms lift the work equipment via the work equipment adapter, the respective lifting pins, the respective lifting arms, and the respective gripping pins such that the spindle openings of the work equipment are aligned with the spindle openings of the first support and the second support.

16. A tractor linkage arrangement according to claim 12, wherein the work equipment is removably mounted via the work equipment adapter to the first support and to the second support, and wherein a first, a second, a third and a fourth spindle are removably inserted to the first, the second, the third and fourth spindle opening of the first and the second support respectively, and further inserted to the first, the second, the third and the fourth spindle opening of the work equipment adapter, respectively.

17. A tractor linkage arrangement according to claim 12, wherein the tractor lifting arms lower the work equipment via the work equipment adapter, the respective lifting pins, the respective lifting arms and the respective gripping pins.

18. A tractor linkage arrangement according to claim 12, wherein the first lifting arm comprises a first lifting pin on one side of the first lifting arm and a first gripping pin on the other side of the lifting arm displaced from the first lifting pin, and further that the second lifting arm comprises a second lifting pin on one side of the second lifting arm and a second gripping pin on the other side of the second lifting arm displaced from the second lifting pin.

19. A tractor linkage arrangement according to claim 12, wherein the first lifting arm comprises a first lifting pin on one side of the first lifting arm and a first gripping pin on the other side of the lifting arm aligned with the first lifting pin, and further that the second lifting arm comprises a second lifting pin on one side of the second lifting arm and a second gripping pin on the other side of the second lifting arm aligned from the second lifting pin.

20. A tractor linkage arrangement according to claim 12, wherein the second and the fourth spindle are fixed to the subframe, and the second and the fourth spindle opening of the work equipment adapter are slots such that they are to be adjusted on top of the second and fourth spindle, respectively.

21. A tractor linkage arrangement according to claim 12, wherein different work equipment adapters are to be attached to different work equipment.

22. A tractor linkage arrangement according to claim 12, wherein the subframe and the spindle openings of the subframe are positioned essentially closer to the rear axle of the tractor than the outermost ends of any of the first lower link, the second lower link and the top link of the three-point linkage.
